(19) United States
(12) Patent Application Publication
(10) Pub. No.: US 2005/0235152 A1
(43) Pub. Date: Oct. 20, 2005

(54) Encryption key sharing scheme for automatically updating shared key

(75) Inventors: Satoshi Ozaki, Kawasaki-shi (JP); Seijiro Yoneyama, Kawasaki-shi (JP); Shigeo Matsuzawa, Chofu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/078,338

(22) Filed: Mar. 14, 2005

(30) Foreign Application Priority Data
Mar. 16, 2004 (JP) 2004-074493

(51) Int. Cl. H04L 9/00

(52) U.S. Cl. 713/170

(57) ABSTRACT

In the encryption key sharing scheme, the eavesdropping of the communication contents by the third person is prevented by automatically updating a shared key which is hard to predict for the third person, by acquiring a seed of the shared key to be used for the encryption of the next communication from the correspondent, without requiring the user to update the shared key at every occasion of the communication with the correspondent.

### CROSS-REFERENCE TO RELATED APPLICATIONS

This application is based upon and claims the benefit of priority from the prior Japanese Patent Application No. 2004-074493, filed on Mar. 16, 2004, the entire contents of which are incorporated herein by reference.

### BACKGROUND OF THE INVENTION

1. Field of the Invention

The present invention relates to a communication device for sharing a key information with a correspondent and carrying out encrypted communications based on this key, and more particularly to a scheme for sharing this key information.

2. Description of the Related Art

In recent years, it becomes possible to manufacture relatively high functional devices at cheap costs, and there are even those devices which have conventionally been used as stand-alone devices such as home electronics devices which are now capable of being connected to the network. On the other hand, as the networking advances, there are growing concerns for the leakage of important information to be kept secret due to the eavesdropping of information flowing through the network or the stealing of the user ID, as well as the illegal remote operations of devices through the network.

In order to avoid such problems, there is a method for transmitting and receiving communication data after encrypting them such that only the correspondents can decrypt the communications between the devices, for the purpose of preventing the eavesdropping by the third person. Here, there is a need to share a key to be used for the encryption, which can only be known by the correspondents. For example, there is a method in which the encryption by the public key cryptosystem is used and a shared key stored in an IC card is exchanged with a remotely located server, as disclosed in Japanese Patent Application Laid Open No. 2001-069138.

However, if the exchange of the information encrypted by using the same key information is continued indefinitely, there is a possibility for this shared key to be cryptoanalyzed sooner or later. It is also possible to analyze the device (IC card, for example) that stores the shared key to reveal the shared key. Also, in the case where it is unavoidable to set the same shared key in advance to a plurality of devices for the purpose of reducing the manufacturing cost, the other devices which have the same shared key are also exposed to these dangers.

### SUMMARY OF THE INVENTION

It is therefore an object of the present invention to provide a scheme for sharing an encryption key in which the eavesdropping of the communication contents by the third person is prevented by automatically updating a shared key which is hard to predict for the third person, by acquiring a seed of the shared key to be used for the encryption of the next communication from the correspondent, without requiring the user to update the shared key at every occasion of the communication with the correspondent.

According to one aspect of the present invention there is provided a communication device, comprising: a memory unit configured to store a first value; a shared key generation unit configured to generate a second value as a shared key to be used in encrypting communication data to be communicated with a correspondent, according to the first value stored in the memory unit; a transmission unit configured to transmit a notice message containing the second value to the correspondent; and a reception unit configured to receive a response message containing a third value from the correspondent and store the third value into the memory unit as the first value to be used in generating the second value next time.

According to another aspect of the present invention there is provided a communication method, comprising: storing a first value in a memory; generating a second value as a shared key to be used in encrypting communication data to be communicated with a correspondent, according to the first value stored in the memory; transmitting a notice message containing the second value to the correspondent; and receiving a response message containing a third value from the correspondent and storing the third value into the memory as the first value to be used in generating the second value next time.

According to another aspect of the present invention there is provided an encryption key sharing method for sharing an encryption key to be used in encrypted communications between a client device and a server device which is a correspondent of the client device, comprising: generating a second value as a shared key to be used in encrypting communication data to be communicated with the server device, according to a first value stored in a memory, at the client device; transmitting a notice message containing the second value from the client device to the server device; receiving the notice message and judging whether the second value is correctly received or not at the server device; transmitting a response message containing a third value from the server device to the client device when the second value is correctly received; and receiving the response message and storing the third value contained in the response message into the memory as the first value to be used in generating the second value next time at the client device.

According to another aspect of the present invention there is provided a computer program product for causing a computer to function as a communication device, the computer program product comprising: a first computer program code for causing the computer to store a first value in a memory; a second computer program code for causing the computer to generate a second value as a shared key to be used in encrypting communication data to be communicated with a correspondent, according to the first value stored in the memory; a third computer program code for causing the computer to transmit a notice message containing the second value to the correspondent; and a fourth computer program code for causing the computer to receive a response message containing a third value from the correspondent and store the third value into the memory as the first value to be used in generating the second value next time.

Other features and advantages of the present invention will become apparent from the following description taken in conjunction with the accompanying drawings.

### BRIEF DESCRIPTION OF THE DRAWINGS

FIG. 1 is a schematic diagram showing an exemplary configuration of a communication system according to one embodiment of the present invention.

FIG. 2 is a sequence chart showing an exemplary communication sequence in the communication system of FIG. 1.

FIG. 3 is a sequence chart showing another exemplary communication sequence in the communication system of FIG. 1.

FIG. 4 is a sequence chart showing another exemplary communication sequence in the communication system of FIG. 1.

FIG. 5 is a block diagram showing an exemplary configuration of a device in the communication system of FIG. 1.

FIG. 6 is a block diagram showing an exemplary configuration of an application server in the communication system of FIG. 1.

FIG. 7 is a flow chart showing an exemplary processing of a device in the communication system of FIG. 1.

FIG. 8 is a flow chart showing an exemplary processing of an application server in the communication system of FIG. 1.

### DETAILED DESCRIPTION OF THE INVENTION

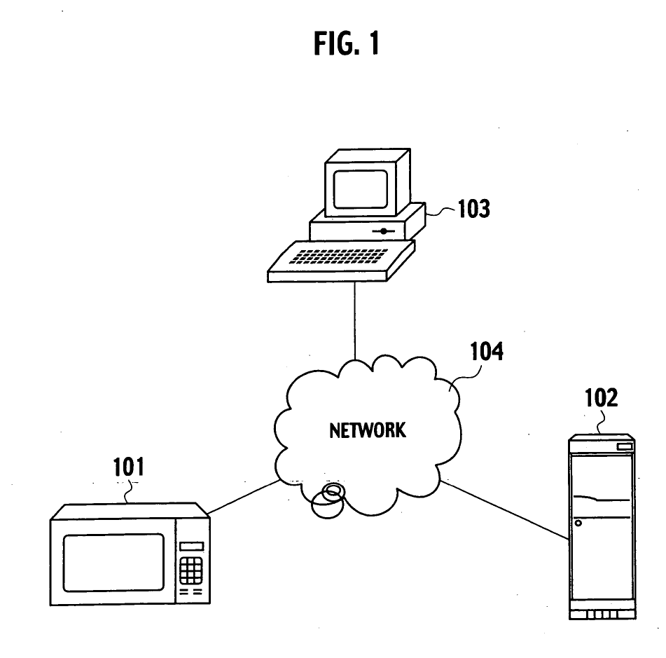

Referring now to FIG. 1 to FIG. 8, one embodiment of the present invention will be described in detail.

FIG. 1 shows an exemplary configuration of a communication system in this embodiment, which comprises a device 101, an application server 102, a setting PC 103, and a network 104.

The device 101 has a communication function such that it can communicate with the application server 102 and the setting PC 103 through the network 104. The device 101 receives operation commands from the other device and responds information regarding its own state in response to an inquiry, through the network 104. Here, an exemplary case where the device 101 is a microwave oven is shown, but the device 101 can be any device which has a communication function capable of communicating through the network 104 such as a general home electronics device or a portable terminal.

The application server 102 has a function for communicating with the device 101 and the setting PC 103 through the network 104, and provides information such as cooking recipe, for example, in response to a request from the device 101 or automatically. Here, the application server 102 has a function for exchanging a shared key with the device 101 and carrying out the encrypted communications using this shared key with the device 101. It is also possible for a device connected to the network 104 (device 101, for example) to play the role of the application server 102 rather than providing the application server 102 as a separate device. In such a case, it is possible to share the shared key between the devices and carry out the encrypted communications between these devices, through the network 104.

The setting PC 103 has a function for communicating with the device 101 and the application server 102 through the network 104. The setting server 1-3 has an interface mainly for the user, such as a display and a keyboard, for example, and a function for setting, state checking and commanding with respect to each device through the network 104. In this embodiment, this function is used for the initial registration to the application server 102, the state check of the device 101, and the command for updating the shared key stored by the device 101, for example.

The network 104 can be any of the communication medium such as a wired LAN, a radio LAN, or a serial communication path, or any other communication medium. It can be replaced by any network in which at least two or more devices connected to the network can transmit and receive encrypted data. As an example, the case of the LAN capable of carrying out packet communications using IP (Internet Protocol) will be described.

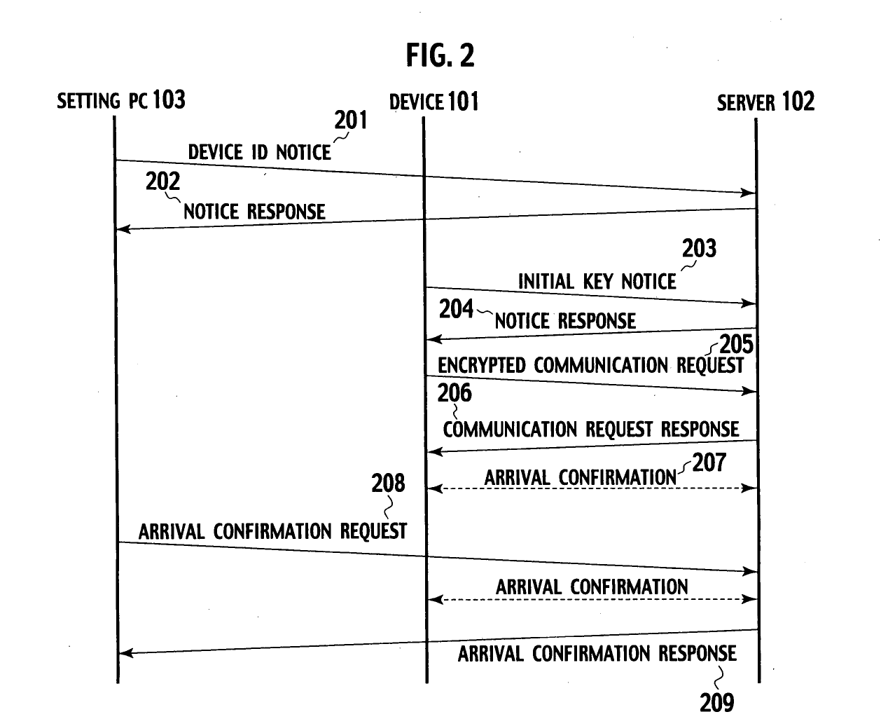

FIG. 2 shows an exemplary communication sequence in the communication system of FIG. 1.

In exchanging the key information, it is not appropriate to exchange the key automatically with any device whenever it is requested, because if the data exchange is possible by simply connecting to the network, there is a possibility for the data to be easily stolen by the malicious third person. There is also a problem for allowing or enabling the device located in the neighboring house to connect to the communication system of this embodiment which is located at one's own house.

For these reasons, in the communication system of this embodiment, at the start of the communication sequence, the identification of the device with which the key should be exchanged (device ID) is notified to the application server 102 by using the setting PC 103 (device ID notice 201). Then, the application server 102 responds information regarding whether it was possible to receive this notice normally or not (notice response 202). At this point, the device ID may be entered into the application server 102 directly without using the setting PC 103. In such a case, the device ID notice 201 and the notice response 202 will be omitted.

When the device ID of the device with which the key will be shared, i.e., the device 101, is notified normally, the user makes a transition of the operation state of the device 101 to a key exchange mode for exchanging the key information with the application server 102. This mode transition may be made by the user by carrying out an operation to switch the operation state of the device 101, but it is also possible to make the device 101 such that the device 101 is set to this mode automatically when the power of the device 101 is turned on, for example. In the case of making a transition to the key exchange mode at a time of turning the power on, the power of the device 101 is turned on when the device ID notice 201 is completed.

The device 101 in the key exchange mode notifies an initial value of the key information to the correspondent to share the shared key which is the cipher key, i.e., the application server 102 (initial key notice 203). This initial value of the key contains an initial value of the shared key and information to be used for the verification of this key. The detail of information will be described below. At this point, the information on the initial value of the key to be transmitted should preferably be encrypted by using the public key provided by the application server 102. The public key cryptosystem used for the encryption of information is in general a cryptosystem in which the encryption and decryption are realized by using two key information including the public key and the secret key. There is a property that data encrypted by using one public key can be decrypted only by using a specific secret key, and data encrypted by using one secret key can be decrypted only by using a specific public key. By using this property, it is possible to notify the correct information only to a specific correspondent. The details of the encryption mechanism itself will not be described here.

When the device 101 that is making the connection is a device that has the device ID notified by the earlier device ID notice 201, the application server 102 judges whether this shared key is correct or not by using the shared key and the information to be used for the verification of this shared key contained in the initial key notice 203 received from the device 101, and responds this judgement result to the device 101 as a notice response 204.

The device 101 which received the notice response 204 requests a start of the cipher communication using the earlier transmitted shared key (encrypted communication request 205). Upon receiving this, if the request of the encrypted communication request 205 is acceptable, the application server 1-2 responds a communication request response 206 for accepting this communication request, which contains information to be a seed when the device 101 generates the shared key next time.

By using the above procedure, the shared key is shared between the device 101 and the application server 102. Then, the device 101 and the application server 102 start the encrypted communications using the shared key, and in order to check whether the encryption and decryption are carried out normally, an arrival confirmation 207 is carried out by transmitting and receiving the encrypted data. Although this arrival confirmation 207 is carried out in this embodiment, it is not absolutely necessary to carry it out after the key sharing.

For example, the user may transmit an arrival confirmation request 208 to the application server 102 at appropriate timing from the setting PC 103 in order to check whether the encrypted communications are carried out normally between the device 101 and the application server 102 or not. In such a case, the application server 102 that received the arrival confirmation request 208 carries out the arrival confirmation 207 with the device 101 and responds its result to the setting PC 103 as an arrival confirmation response 209.

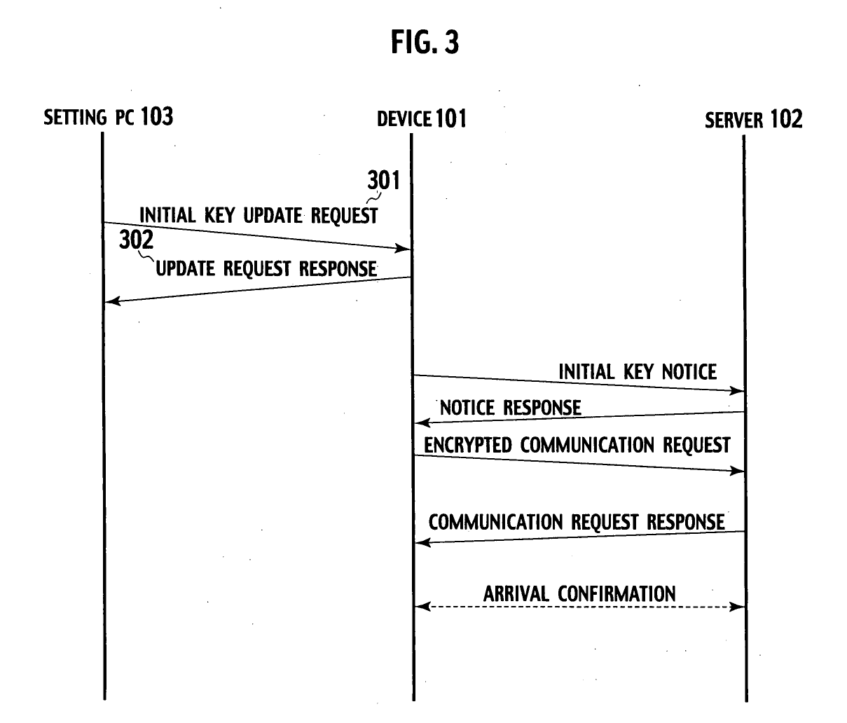

FIG. 3 shows an exemplary communication sequence for commanding a setting of a new shared key to the device 101 in the communication system of FIG. 1.

When it is desired to update the shared key to be used for the encrypted communications with the application server 102, the user commands the update of the shared key to the device 101 (initial key update request 301). The device 101 that received this command responds an update request response 302 to the setting PC 103, and make a transition of the own operation state to the key exchange mode. By this operation, the device 101 shares a new shared key with the application server 102 through the initial key notice 203, the notice response 204, the encrypted communication request 205 and the communication request response 206 described above.

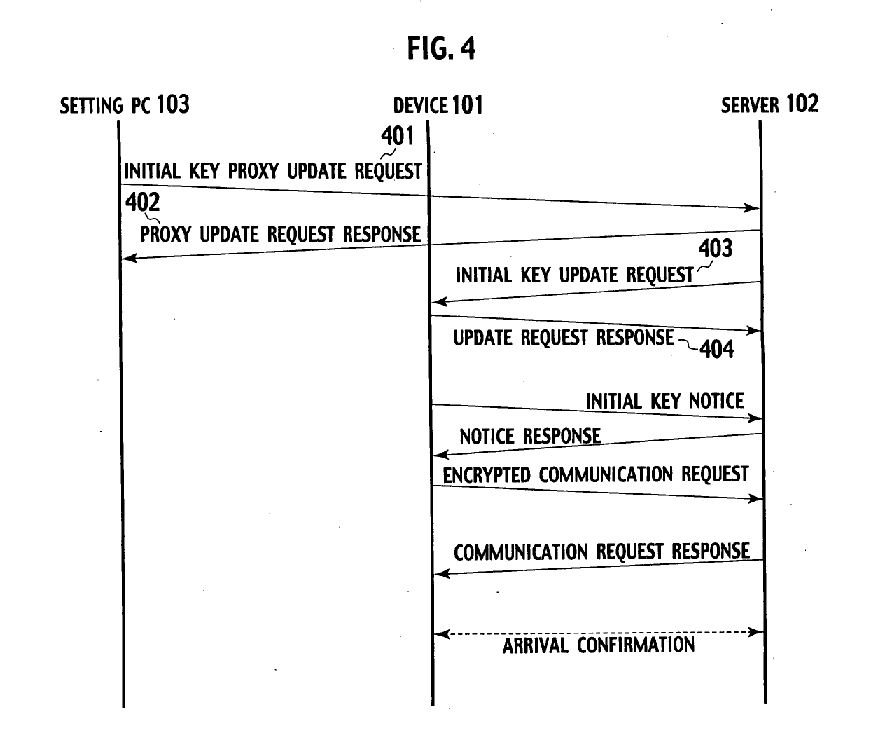

FIG. 4 shows another exemplary communication sequence for commanding a setting of a new shared key to the device 101 in the communication system of FIG. 1.

Instead of requesting an update of the shared key from the setting PC 103 to the device 101 directly, the setting PC 103 solicits application server 102 to make the shared key update request to the device 101 as a proxy of the setting PC 103. The setting PC 103 transmits an initial key proxy update request 401 containing the device ID or the like for indicating the device whose shared key should be updated, to the application server 102. The application server 102 responds a response to this request as a proxy update request response 402, to the setting PC 103.

Next the device whose shared key should be updated is identified from the device ID or the like contained in the initial key proxy update request 401, Then, a request for updating the shared key stored in this device is transmitted to the identified device (which is assumed to be the device 101 here) (initial key update request 403). Then, the device 101 that received this request responds an update request response 404 to the application server 102, and makes a transition of the own operation state to the key exchange mode. By this operation, the device 101 shares a new shared key with the application server 102 through the initial key notice 203, the notice response 204, the encrypted communication request 205 and the communication request response 206 described above.

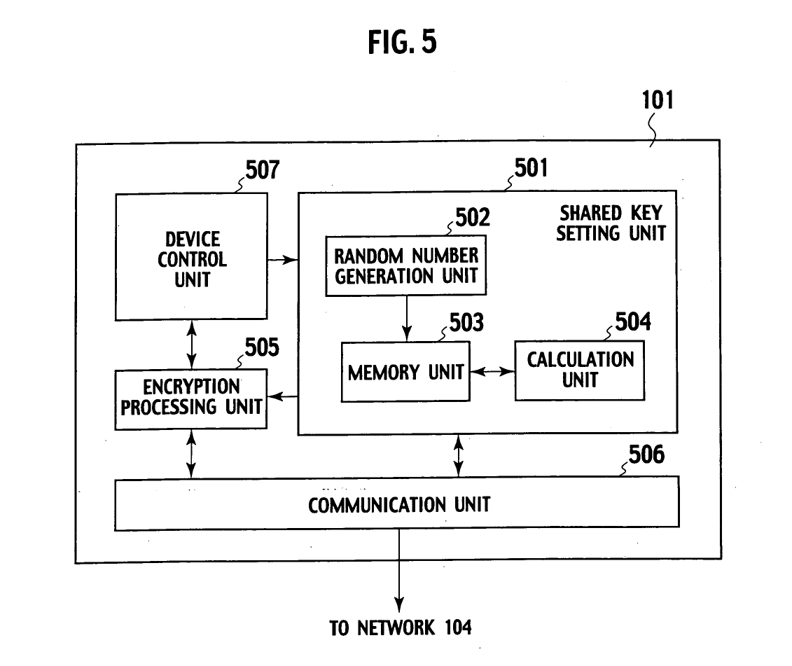

FIG. 5 shows an exemplary configuration of the device 101 in this embodiment. The device 101 of FIG. 5 has a shared key setting unit 501 containing a random number generation unit 502, a memory unit 503 and a calculation unit 504, an encryption processing unit 505, a communication unit 506, and a device control unit 507.

The shared key setting unit 501 has functions for generating the shared key to be used when the device 101 carries out the encrypted communications with the other device with which the key information is shared by the exchange with the other device, setting this generated key information as the encryption key in the encryption processing unit 505, and notifying the key information to the other device. In the following, each function of the shared key setting unit 501 will be described separately.

The random number generation unit 502 has a function for generating a random number. The random number here may include a pseudo-random number generated according to some rules.

The memory unit 503 has a function for storing the random number generated by the random number generation unit 502, a calculation value calculated by the calculation unit 504, and information received from the other device.

The calculation unit 504 carries out the calculation based on a value stored in the memory unit 503 and stores it back into the memory unit 503. The calculation carried out by the calculation unit 504 includes a concatenation of a plurality of numerical value data, a one-way conversion of some numerical value by the hash function, etc.

The encryption processing unit 505 has a function for encrypting the communication data to be transmitted or decrypting the received communication data when the shared key setting unit 501 or the device control unit 507 exchanges the data to be communicated with the other device. The encryption processing unit 505 is used for both the public key cryptosystem for encrypting/decrypting data by using the public key provided by the correspondent, and the shared key cryptosystem for encrypting/decrypting data by using the shared secret key, at a time of the encryption/decryption. At least in the case of the encryption/decryption using the secret key, the shared key corresponding to this secret key is acquired from the shared key setting unit 501.

The communication unit 506 has a function for communicating with the other device through the network 104. The necessary function is usually different depending on the communication medium to be used for the communications. Here, it is assumed that the function necessary for the communications using the communication medium of the network 104 is provided.

The device control unit 507 is a portion for controlling the operation of the device 101 itself, which may include an acquisition of a cooking recipe information and a notification of information on a cooking state in the case of the microwave oven, and a control of a display on an operation panel or the power unit provided on the device 101. When the device control unit 507 needs to communicate with the other device through the network 104 in relation to the control of the device 101 itself, the communication data are encrypted/decrypted by the encryption processing unit 505, so that the communication data to be exchanged by this communication are transmitted in an encrypted form on the network 104.

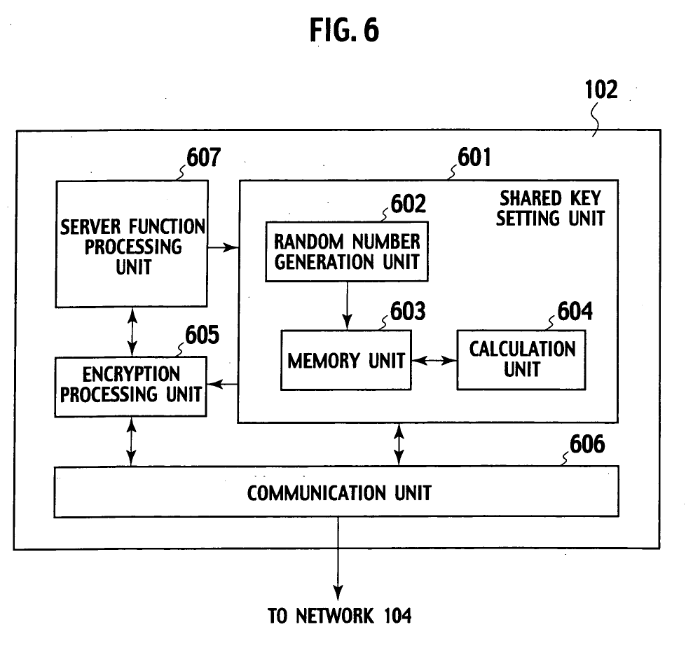

FIG. 6 shows an exemplary configuration of the application server 102 in this embodiment. The application server 102 of FIG. 6 has a shared key setting unit 601 containing a random number generation unit 602, a memory unit 603 and a calculation unit 604, an encryption processing unit 605, a communication unit 606, and a server function processing unit 607.

The shared key setting unit 601 has functions for judging whether this device is a device to be communicated with from the received key setting information containing the shared key when the application server 102 carries out the encrypted communication with the other device with which the key information is shared, setting this shared key information as the encryption key in the encryption processing unit 605, and transmitting a seed of the shared key to be used at a time of next communication to the other device. In the following, each function of the shared key setting unit 601 will be described separately.

The random number generation unit 602 has a function for generating a random number. The random number here may include a pseudo-random number generated according to some rules.

The memory unit 603 has a function for storing the random number generated by the random number generation unit 602, a calculation value calculated by the calculation unit 604, and information received from the other device.

The calculation unit 604 carries out the calculation based on a value stored in the memory unit 603 and stores it back into the memory unit 603. The calculation carried out by the calculation unit 604 includes a division of numerical value data, a numerical value comparison calculation, etc.

The encryption processing unit 605 has a function for encrypting the communication data to be transmitted or decrypting the received communication data when the shared key setting unit 601 or the server function processing unit 607 exchanges the data to be communicated with the other device. The encryption processing unit 605 is used for both the public key cryptosystem for encrypting/decrypting data by using the public key provided by the correspondent, and the shared key cryptosystem for encrypting/decrypting data by using the shared secret key, at a time of the encryption/decryption. At least in the case of the encryption/decryption using the secret key, the shared key corresponding to this secret key is acquired from the shared key setting unit 601.

The communication unit 606 has a function for communicating with the other device through the network 104. The necessary function is usually different depending on the communication medium to be used for the communications. Here, it is assumed that the function necessary for the communications using the communication medium of the network 104 is provided.

The server function processing unit 67 is a portion for controlling the operation of the application server 102 itself, which may include a function for receiving a request and a function for storing and extracting necessary information, and a function for transmitting this information to the other device, if it is a server provided for the purpose of providing a cooking recipe information or the like upon receiving a request from the other device, for example. When the server function processing unit 607 needs to communicate with the other device through the network 104, the communication data are encrypted/decrypted by the encryption processing unit 605, so that the communication data to be exchanged by this communication are transmitted in an encrypted form on the network 104.

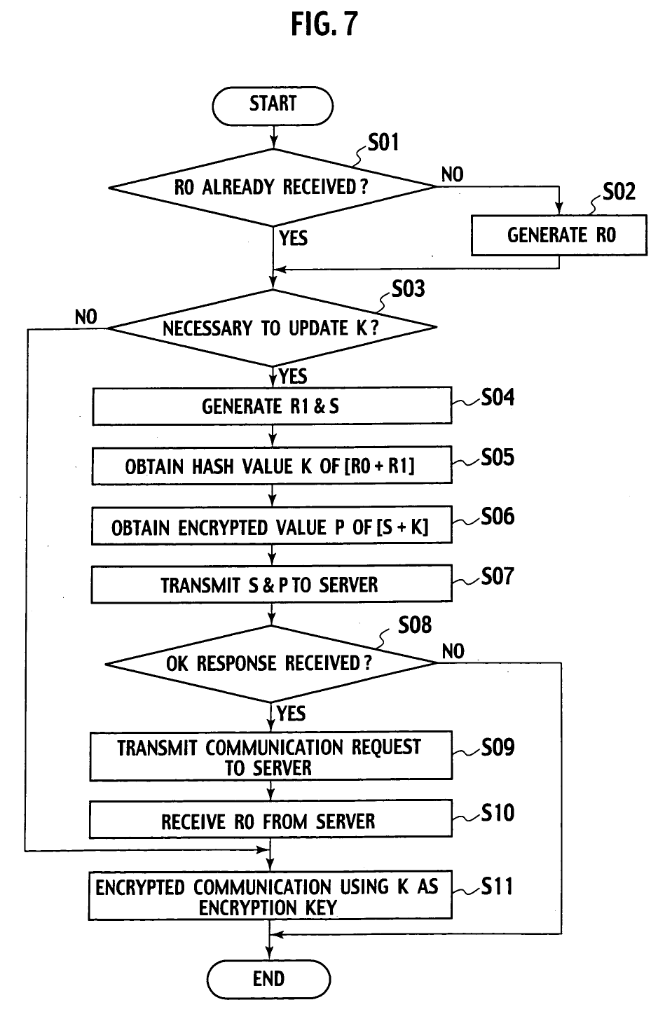

FIG. 7 shows an exemplary processing of the device 101 in this embodiment. When the processing of the device 101 is started, whether R0 which is a seed of the shared key to be shared is acquired from the other device and stored in the memory unit 503 or not is judged (step S01). R0 indicates a value of the seed of the shared key contained in the communication request response 206. If R0 which should be received by the communication request response 206 is not stored, the device 101 itself generates R0 by the random number generation unit 502 and stores it into the memory unit 503 (step S02). The case where R0 is not stored is the state immediately after the power of the device 101 is turned on, for example.

Next, whether there is a need to update the shared key to be used for the encrypted communication with the application server 102 or not is judged (step S03). Here, it is judged that there is a need to update the shared key in the case where R0 has never been acquired from the other device as it is immediately after the activation of the device 101, the case the initial key update request 301 is received from the setting PC 103, and the case where the initial key update request 403 is received from the application server 102, for example. Alternatively, if it is configured such that the shared key is to be updated whenever the communications for a prescribed number of times or a prescribed period of time are carried out, it is the time of the communication after the prescribed number of times or the prescribed period of time. When it is none of these cases and there is no need to update the currently utilized shared key, the encryption processing unit 505 carries out the communications with the application server 102 while encrypting/decrypting the communication data by using the currently utilized shared key (step S11).

When it is judged that there is a need to update the shared key at the step S03, values of R1 and S are determined by the random number generated by the random number generation unit 502 and stored into the memory unit 503 (step S04). Then, R0 and R1 stored in the memory unit 503 are combined by concatenating them and then the shared key K is obtained by applying the one-way hash function by the calculation unit 504, and they are stored into the memory unit 503 (step S05). Here, the application of the one-way hash function to the combination of R0 and R1 is one method for obtaining the pseudo-random number with higher unpredictability by setting R1 to be a value dependent on that device (the device ID or a value regarding the operation state of that device, for example). Thus the specification such as a method for combining R0 and R1, the code length, etc., is not necessarily limited to the method described here. For example, it is possible to use the value of R0 as a seed of the random number generation unit 502 at a time of generating R1 at the step S04. In this case, depending on the way of selecting R0, it is possible to make the unpredictability of the shared key K sufficiently high by R1 alone so that a value obtained by applying the hash function to R1 can be used as the shared key K. Of course, it is also possible to use a value obtained by applying the one-way hash function to R0 as the shared key K.

Next, K and S obtained at the step S05 is combined in a separable form according to prescribed rules, and P is obtained by encrypting this combined data by using the public key provided from the application server 102, and stored into the memory 503 (step S06). Then, information on P and S is transmitted to the application server 102 as the initial key notice 203 (step S07).

Then, the permission/refusal information contained in the response notice 204 from the application server 102 based on a result of verifying values of P and S is judged (step S08). If the judgement result is “OK”, the encrypted communication request 205 is transmitted to the application server 102 to request the start of the encrypted communication using the shared key K sent by the initial key notice 203 (step S09), and the communication request response 206 for responding to this request is received from the application server 102. The device 101 extracts R0 contained in this communication request response 206, and stores it into the memory unit 503 (step S10). Then, the encryption processing unit 505 carries out the communications with the application server 102 while encrypting/decrypting the communication data by using the currently stored shared key K (step S11).

On the other hand, when the judgement result at the step S08 is not “OK”, it implies that the encrypted communication with the application server 102 is refused for some reason, so that the processing is finished without any further operation.

By using such a configuration, by acquiring a value to be a seed of the shared key generation from the other device, without setting the fixed shared key to the device 101, it is possible to automatically generate and share the shared key for each device which is difficult to predict for the third person, by the device itself.

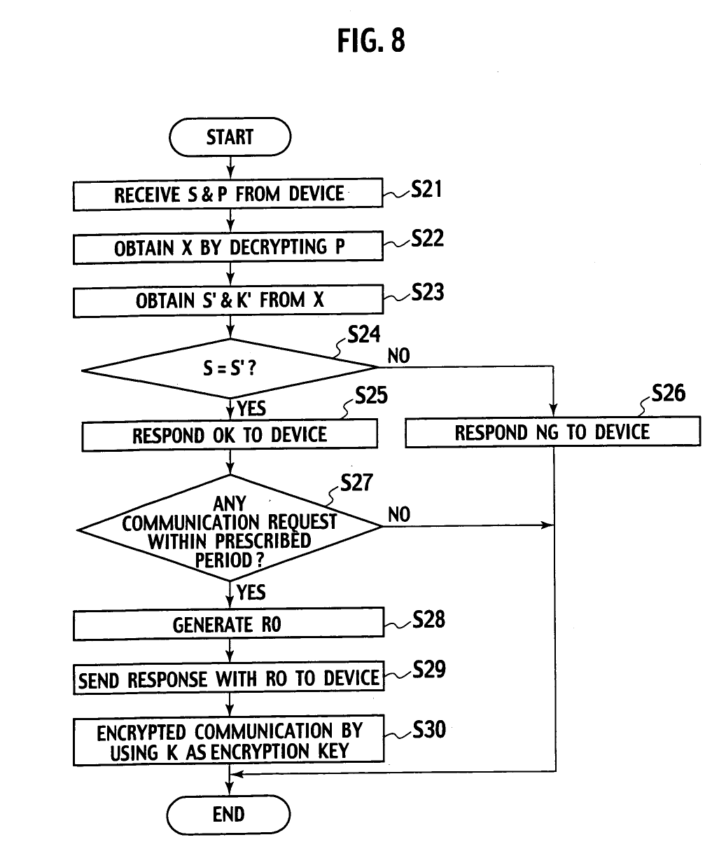

FIG. 8 shows an exemplary processing of the application server 102 in this embodiment.

First, the application server receives the initial key notice 203 from the device 101, extracts S and P contained therein and stores them into the memory unit 603 (step S21). Next, X is obtained by decrypting P by using the own secret key, and stored into the memory unit 603 (step S22). The calculation unit 604 separates the stored X into S and K according to the rules used in combining them, to obtain S′ corresponding to S and K′ corresponding to K, and stores them into the memory unit 603 (step S23).

Next, S stored earlier and S′ are compared (step S24). Here, whether the device 101 encrypted data by using the public key provided by the application server 102 or not is judged, because S′ obtaining by decrypting the encrypted data of a value containing S by using the secret key becomes identical to S only when it is encrypted by using the public key corresponding to this secret key in general. Thus the fact that S and S′ become the same value implies that K′ is identical to K transmitted by the device 101.

When S and S′ are different at the step S24, the notice response 204 indicating “NG” to the device 101 which transmitted the initial key notice 203 containing this value is responded and the processing is finished (step S26).

When S and S′ are identical, the notice response 204 indicating “OK” is responded to the device 101 (step S25), and the encrypted communication request 205 from the device 101 is waited (step S27).

When the encrypted communication request 205 from the device 101 is not received within a prescribed period of time since the notice response 204, the processing is finished without carrying out the encrypted communication with the device 101 (step S27). By using such a configuration, it is possible to avoid the waste of the communication resource of the application server 102 by keep maintaining a waiting state for the case where only the initial key notice 203 is made, so that it is possible to expect the effect of avoiding the danger of the service impossible attack by the malicious user, for example.

When the encrypted communication request 205 arrives from the device 101 which transmitted the initial key notice 203 within a prescribed period of time, the random number is generated by the random number generation unit 602, and its value is stored into the memory unit 603 as R0 (step S28). Then, the communication request response 206 containing this R0 and information indicating the acceptance of this request is responded to the device 101 as a response to the encrypted communication request 205 (step S29). By the exchange up to this point, the shared key is shared between the device 101 and the application server 102, so that the encrypted communication using the shared key K is carried out next (step S30).

By using such a configuration, it is possible to carry out the encrypted communications using the shared key which is difficult to predict for the third person, by generating the pseudo-random number with a sufficiently high unpredictability at the application server 102 side and providing it as a seed of the shared key to be set by the correspondent device, even in the case of the encrypted communications with the low function device which cannot generate the pseudo-random number with a sufficiently high unpredictability, for example.

In the communication system of this embodiment, the case of the key sharing between the device 101 and the application server 102 has been described. In the case where there is a device which has a trusting relationship with the application server 102 and which is different from the device 101, it is possible to realize the key sharing between such a device and the device 101 through the application server 102.

Both devices have the encrypted communications with the same application server 102 established, so that when the application server 102 relays the contents of the encrypted communications, the key sharing procedure similar to that carried out between the device 101 and the application server 102 can be carried out between these devices.

Else if the key sharing between the both devices and the application server 102 is realized according to this embodiment, but the encrypted communications are already established, the key sharing procedure with the both devices can be simplified further. The simplest method is to simply transmit the shared key from one device to another device through the application server 102.

Moreover, when one device is carrying out the encrypted communication by the key exchange different from this embodiment such as SSL (Secure Socket Layer) with the application server 102, it is possible to apply the communication system of this embodiment. In this case, the reduction of the procedure at a time of carrying out the encrypted communication, or the encrypted communication suitable for that device such as the stronger cipher communication can be selected, according to the configuration of this device, the importance, the connection frequency, the connection time, etc.

By such a configuration, it is possible to exchange the shared key for the encrypted communications between a plurality of devices for communicating with the application server 102, according to the trusting relationship with the application server 102.

As described, according to the present invention it is possible to provide a scheme for sharing an encryption key in which the eavesdropping of the communication contents by the third person is prevented by automatically updating a shared which is hard to predict for the third person, by acquiring a seed of the shared key to be used for the encryption of the next communication from the correspondent, without requiring the user to update the shared key at every occasion of the communication with the correspondent.

It is also to be noted that, besides those already mentioned above, many modifications and variations of the above embodiments may be made without departing from the novel and advantageous features of the present invention. Accordingly, all such modifications and variations are intended to be included within the scope of the appended claims.

1. A communication device, comprising:
a memory unit configured to store a first value;
a shared key generation unit configured to generate a second value as a shared key to be used in encrypting communication data to be communicated with a correspondent, according to the first value stored in the memory unit;
a transmission unit configured to transmit a notice message containing the second value to the correspondent; and
a reception unit configured to receive a response message containing a third value from the correspondent and store the third value into the memory unit as the first value to be used in generating the second value next time.

2. The communication device of claim 1, further comprising:
a numerical value generation unit configured to generate a numerical value according to prescribed rules;
wherein the shared key generation unit generates the second value according to the first value and the numerical value.

3. The communication device of claim 1, further comprising:
an encryption unit configured to encrypt the second value by using a public key provided by the correspondent;
wherein the transmission unit transmits the notice message containing the second value as encrypted by the encryption unit.

4. The communication device of claim 1, further comprising:
a value generation unit configured to generate the first value according to prescribed rules and store the first value into the memory unit, before the shared key generation unit generates the second value, when the first value is not stored in the memory unit.

5. The communication device of claim 1, further comprising:
an encrypted communication unit configured to carry out encrypted communications with the correspondent by encrypting the communication data by using the second value as the shared key.

6. A communication method, comprising:
storing a first value in a memory;
generating a second value as a shared key to be used in encrypting communication data to be communicated with a correspondent, according to the first value stored in the memory;
transmitting a notice message containing the second value to the correspondent; and
receiving a response message containing a third value from the correspondent and storing the third value into the memory as the first value to be used in generating the second value next time.

7. The communication method of claim 6, further comprising:
generating a numerical value according to prescribed rules;
wherein the second value is generated according to the first value and the numerical value.

8. The communication method of claim 6, further comprising:
encrypting the second value by using a public key provided by the correspondent;
wherein the transmitting step transmits the notice message containing the second value as encrypted by the encrypting step.

9. The communication method of claim 6, further comprising:
generating the first value according to prescribed rules and storing the first value into the memory, before the second value is generated, when the first value is not stored in the memory.

10. The communication method of claim 6, further comprising:
carrying out encrypted communications with the correspondent by encrypting the communication data by using the second value as the shared key.

11. An encryption key sharing method for sharing an encryption key to be used in encrypted communications between a client device and a server device which is a correspondent of the client device, comprising:
generating a second value as a shared key to be used in encrypting communication data to be communicated with the server device, according to a first value stored in a memory, at the client device;
transmitting a notice message containing the second value from the client device to the server device;
receiving the notice message and judging whether the second value is correctly received or not at the server device;
transmitting a response message containing a third value from the server device to the client device when the second value is correctly received; and
receiving the response message and storing the third value contained in the response message into the memory as the first value to be used in generating the second value next time at the client device.

12. The encryption key sharing method, further comprising:
transmitting an encrypted communication request for requesting start of the encrypted communications from the client device to the server device, after transmitting the notice message;
wherein the server device transmits the response message when the encrypted communication request is received within a prescribed period of time since the notice message is received.

13. A computer program product for causing a computer to function as a communication device, the computer program product comprising:
a first computer program code for causing the computer to store a first value in a memory;
a second computer program code for causing the computer to generate a second value as a shared key to be used in encrypting communication data to be communicated with a correspondent, according to the first value stored in the memory;
a third computer program code for causing the computer to transmit a notice message containing the second value to the correspondent; and
a fourth computer program code for causing the computer to receive a response message containing a third value from the correspondent and store the third value into the memory as the first value to be used in generating the second value next time.

14. The computer program product of claim 13, further comprising:
a fifth computer program code for causing the computer to generate a numerical value according to prescribed rules;
wherein the second computer program code generates the second value according to the first value and the numerical value.

15. The computer program product of claim 13, further comprising:
a fifth computer program code for causing the computer to encrypt the second value by using a public key provided by the correspondent;
wherein the third computer program code transmits the notice message containing the second value as encrypted by the fifth computer program code.

16. The computer program product of claim 13, further comprising:
a fifth computer program code for causing the computer to generate the first value according to prescribed rules and store the first value into the memory, before the second value is generated, when the first value is not stored in the memory.

17. The computer program product of claim 13, further comprising:
a fifth computer program code for causing the computer to carry out encrypted communications with the correspondent by encrypting the communication data by using the second value as the shared key.
